(19) United States
(12) Patent Application Publication
(10) Pub. No.: US 2017/0079886 A1
(43) Pub. Date: Mar. 23, 2017

(54) PILL CAP APPARATUS AND METHOD OF USE

(71) Applicants: Arslanbek Sagynaliev, Mundelein, IL (US); Chinglis Aloev, Mundelein, IL (US)

(72) Inventors: Arslanbek Sagynaliev, Mundelein, IL (US); Chinglis Aloev, Mundelein, IL (US)

(21) Appl. No.: 15/269,560

(22) Filed: Sep. 19, 2016

Related U.S. Application Data
(60) Provisional application No. 62/220,639, filed on Sep. 18, 2015.

(51) Int. Cl. A61J 7/04; B65D 41/04; A61J 1/03

(52) U.S. Cl. CPC A61J 7/04; A61J 1/03; B65D 41/0407

(57) ABSTRACT

A pill cap apparatus and method of use is disclosed herein. The pill cap attaches to bottles and containers to aid in patient compliance with a dosage regimen using solid dosage units of medicine such as pills, capsules and tablets.

### CROSS-REFERENCE TO RELATED APPLICATION

The present application claims priority to U.S. Provisional Application Ser. No. 62/220,639, filed Sep. 18, 2015, herein incorporated by reference in its entirety.

### BACKGROUND

The invention relates generally to a medication reminder device. More specifically, the invention relates to a pill cap medication reminder device using a time/day indicator.

Millions of people annually take medications for a specific, short term illness, or over the counter medications for a specific ailment. In recent years, the incident of overdose has dramatically risen leaving the medical profession liable for damages as a result of such overdoses. With the medications needed at specific intervals, the need for a reminder of when a dosage was taken or next needs to be taken is critical. Other known devices such as U.S. PG Pub. No. 2006/0180566A1 and U.S. Pat. No. 4,405,045 is one dimensional in their approach with the only application being in conjunction with a vial provided by the pharmacy or other medical professional. Such known devices are typically bulky and overly complicated with a variety of date, day and time functions. The device(s) is more or less designed to be useful in the long term administration of medicine, as opposed to short term doses, and is not particularly adaptable to medications that come in boxes, tubes or oddly shaped bottles. Furthermore, these devices rely heavily on the long term calibration between the device and the prescription frequency on the label of the bottle itself. Other known devices attempt to provide the user with a similar result but require the wholesale transfer of the medication from the original container to a new reminder device.

U.S. Pat. No. 5,152,422 and U.S. Pat. No. 5,313,439 accomplish the goal of reminding the patient of the next interval for taking the prescribed medication while sacrificing valuable prescription medication information that is typically presented on the original bottle from the pharmacist. The prescription information or directions contained on the bottle or box is important to the patient to confirm or remind the patient of the proper interval. Should a patient transfer its medication to such a device, then dispose of the original container, and then potentially forget or miss-calibrate the device, the patient could be susceptible to an overdose. In addition, such devices potentially introduce the problem of not being able to later identify the medication as it is no longer clearly identified on the label. Thus, such devices are only valuable to long term patients or chronic patients who consistently take the same medication, at the same intervals over long periods of time. Such devices do not serve the non-chronic or temporary patients well. Additionally, such devices are not readily adaptable to medications that come in boxes or tubes or are purchased over the counter.

Other known devices such as U.S. Pat. No. 4,345,541 attempt to yield the same results but have the (potentially) fatal flaw of rotation to the outer ring of the device thus making the device highly susceptible to unwanted or undesired movement. With the ease of change to the timing devices, a user can never be completely sure that the interval shown on the dials has not inadvertently been moved or adjusted. Similarly, U.S. Pat. No. 5,377,614 introduces the potential for error in use of the two dials. Should the dials be reset accidentally, the user would be left without a clear indication of when the last dose was administered and when the next dose should be administered.

Therefore, there is found a need for a reliable, inexpensive and reminder device to aid in reminding patient of the intervals at which they are due to ingest specific dosages of medicine.

### SUMMARY OF THE INVENTION

Provided herein are systems, methods and compositions for a pill cap apparatus. The pill cap apparatus comprises a circular enclosure including a top portion and a bottom portion, wherein the bottom portion engages a top portion of a bottle, and top portion includes a window; a central pin disposed through the central axis of the circular enclosure; a circular disc disposed in the top portion of the circular enclosure, wherein the circular disc includes a plurality of indicators to indicate to the user which day or time remains to take a pill or medication, and the circular disc fixedly attached to the central pin; a seal disposed on a bottom portion of the central pin as to seal the circular enclosure from the bottle; a spring operably coupled with the top portion of the seal and the top portion of the circular enclosure; wherein the circular enclosure rotates a single indicator when the circular enclosure is rotated to close on the top portion of the bottle.

The methods, systems, and apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed.

### BRIEF DESCRIPTION OF THE DRAWINGS

In the accompanying figures, like elements are identified by like reference numerals among the several preferred embodiments of the present invention.

FIG. 1 is a side view of the of the pill cap disposed over a medication bottle.

FIG. 2 is a perspective view of the bottle showing the top portion and tamper mechanism.

FIG. 3A is a cross sectional view of one embodiment of the pill cap.

FIG. 3B is a cross sectional view of another embodiment of the pill cap

FIG. 4A is a top view of the pill cap showing the indicator through the window.

FIG. 4B is a top view of one embodiment of the circular portion.

FIG. 5 is a top view of the circular disc showing the plurality of indicators disposed along the circumference of the circular disc.

FIG. 6 is a top view of the seal.

FIG. 7 is a top view of an alternative embodiment of the circular disc.

FIG. 8 is perspective view of an alternative embodiment of the bottle.

FIG. 9A is a perspective view of an alternative embodiment of the pill cap; FIG. 9B is side view of an alternative embodiment of the pill cap; and FIG. 9C is a cross-sectional view of an alternative embodiment of the pill cap.

FIG. 10A is a top view of the circular enclosure; and FIG. 10B is a top view of the pill cap.

FIG. 11A is a cross-sectional view of an alternative embodiment of the circular enclosure; and FIG. 11B is a cross-sectional view of an alternative embodiment of the circular disc.

### DETAILED DESCRIPTION OF THE INVENTION

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

The use of the terms “a” and “an” and “the” and similar referents in the context of describing the invention are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein. The word “about,” when accompanying a numerical value, is to be construed as indicating a deviation of up to and inclusive of 10% from the stated numerical value. The use of any and all examples, or exemplary language (“e.g.” or “such as”) provided herein, is intended merely to better illuminate the invention and does not pose a limitation on the scope of the invention unless otherwise claimed. No language in the specification should be construed as indicating any nonclaimed element as essential to the practice of the invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present embodiments relate to a pill cap for attaching to bottles and containers to aid in patient compliance with a dosage regimen using solid dosage units of medicine such as pills, capsules and tablets. One or more embodiment provides a simple solution for recording the last dosage that has been taken. The problem with taking medication is that a user forgets that they have already taken a particular dosage of the medication, causing that user to take a particular dosage of medication twice. The pill cap can prevent a user from taking too much medication which can lead to overdose, stroke, death, or some other complication. Embodiments of the pill cap enable users to be reminded of the time the last dosage was taken. The pill cap can be helpful to users with faulty memories and to elderly users. For example, on prescription medicine containers, labels tell a patient when to take a dosage of the medication; however the label does not tell the patient when the patient took a dosage of the medication. The pill cap can provide patients, paramedics, and other persons with an indication of the last dosage the patient has taken, thereby avoiding overdose and other such dangers. The pill cap can allow paramedics responding to an emergency situation to be able to identify the dosages of medications taken and not taken by a particular patient, thereby aiding in their assistance to the patient.

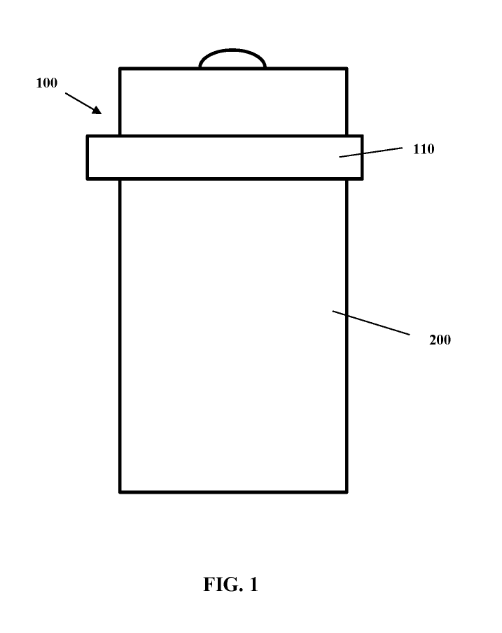

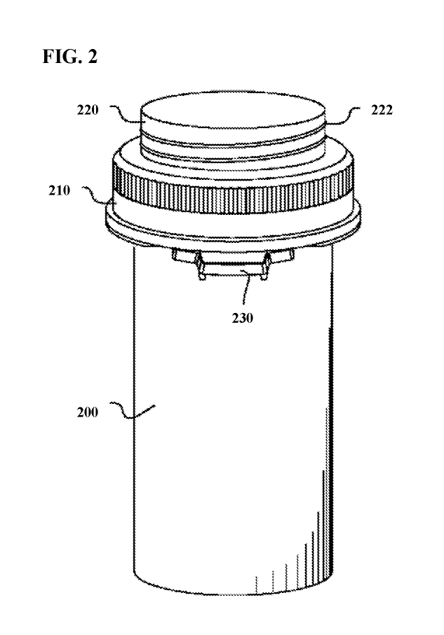

Generally speaking, the pill cap 100 is shown in FIG. 1 disposed over a medication bottle 200. The pill cap 100 includes a bottom portion 110 that threads onto the top portion 210 of the bottle 200. The top portion 210 of the bottle 200 is shown in FIG. 2. The top portion 210 includes a threaded region 220 including a single thread 222 helically wrapped around the threaded region. The embodiment depicted is child resistant, wherein lever 230 can be held down, such as with a user's thumb, and then the pill container 100 can be turned counter clockwise about the bottle 200 to remove the pill container 100. The lever operates as a child-resistant feature of a medicine bottle or container and can remain functional when the pill cap is installed on the medicine bottle or medicine container.

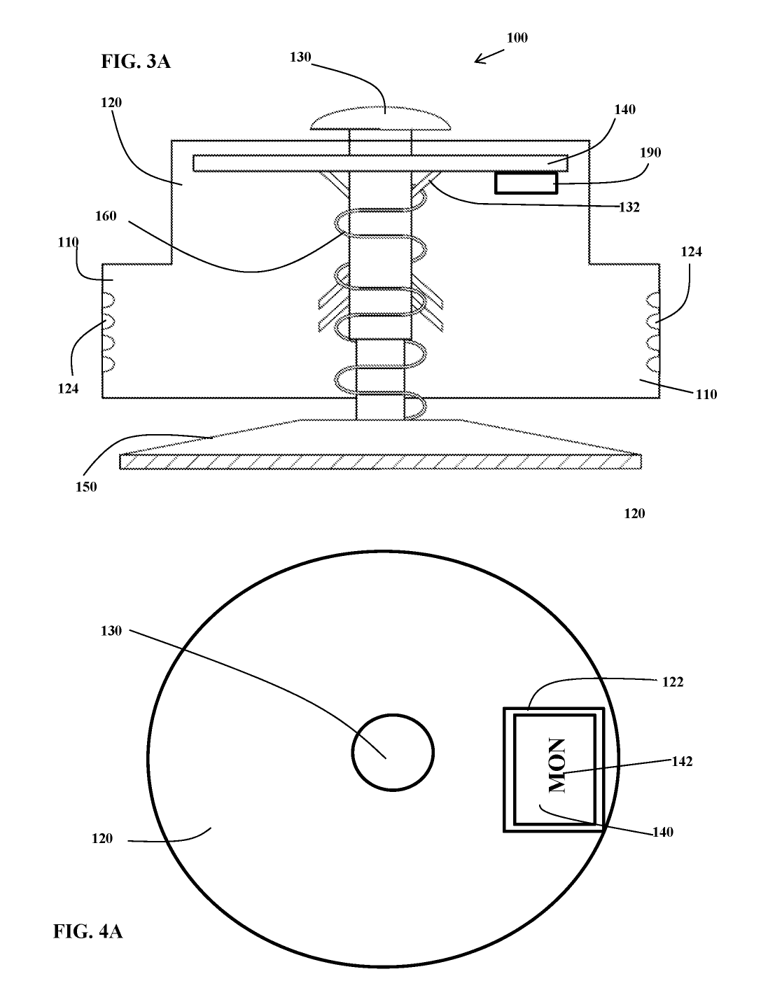

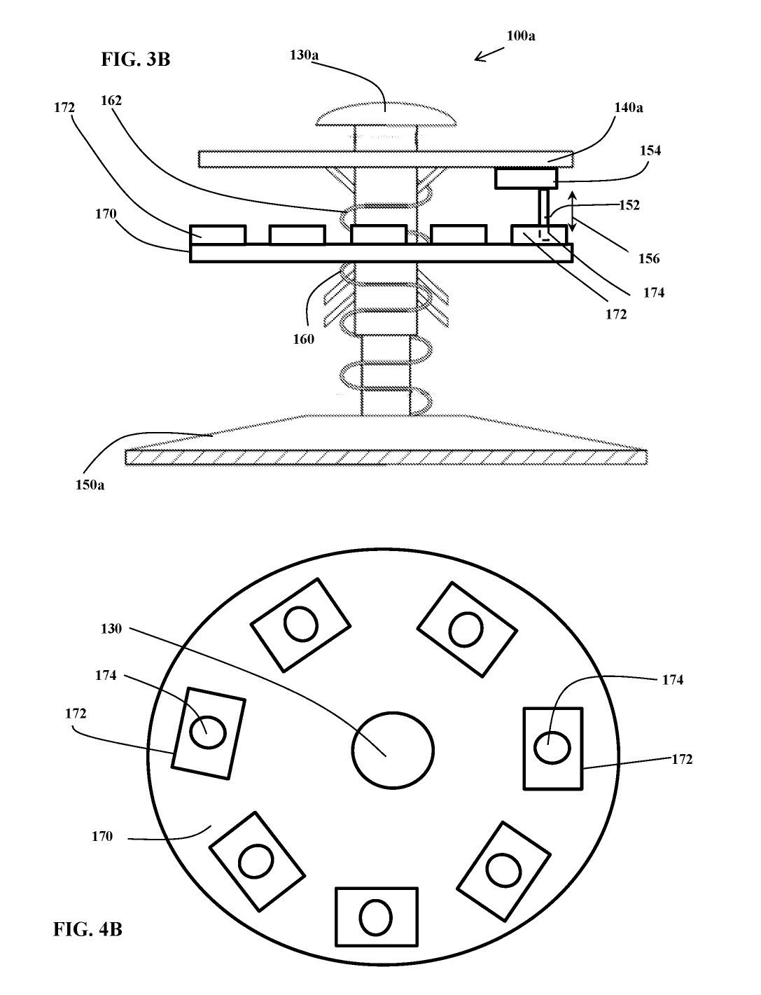

As shown in FIG. 3A, the pill cap 100 comprises a circular enclosure 120, a central pin 130 disposed through the central axis of the circular enclosure 120. The bottom ridged portion 110 includes a plurality of threaded receptions 124 as to receive the threaded region 220 of the bottle 200 and to secure the circular enclosure 120 to the bottle by way of rotation by the user. The circular enclosure 120 includes a circular disc 140 disposed on the top portion of the circular enclosure 120. The circular disc 140 will include a plurality of indicators to indicate to the user which day or time remains to take a pill or medication. The circular disc 140 may be secured to the central pin 130 by way of tabs 132 or other securing methods as to not allow the circular disc 140 to rotate when the circular enclosure rotates. A seal 150 is disposed on the bottom portion of the central pin 130 as to secure the circular enclosure 120 and prevent pills or medication from entering the circular enclosure 120 when disposed on the bottle 200. A spring 160 is operably coupled with the top portion of the seal 150 as to bias the seal 150. The bottom portion of the seal 150 is shown in FIG. 6, operably coupled with the bottom portion of the spring 160. In one embodiment, the seal is a rubber seal that is able to flex or seal the top portion of the bottle 200. Alternatively, the spring 160 serves to allow the circular enclosure 120 to rotate exactly one indicator or one section on the circular disc 140, as further described below. In another embodiment, the spring 160 serves to rotate the circular disc 140 exactly one indicator.

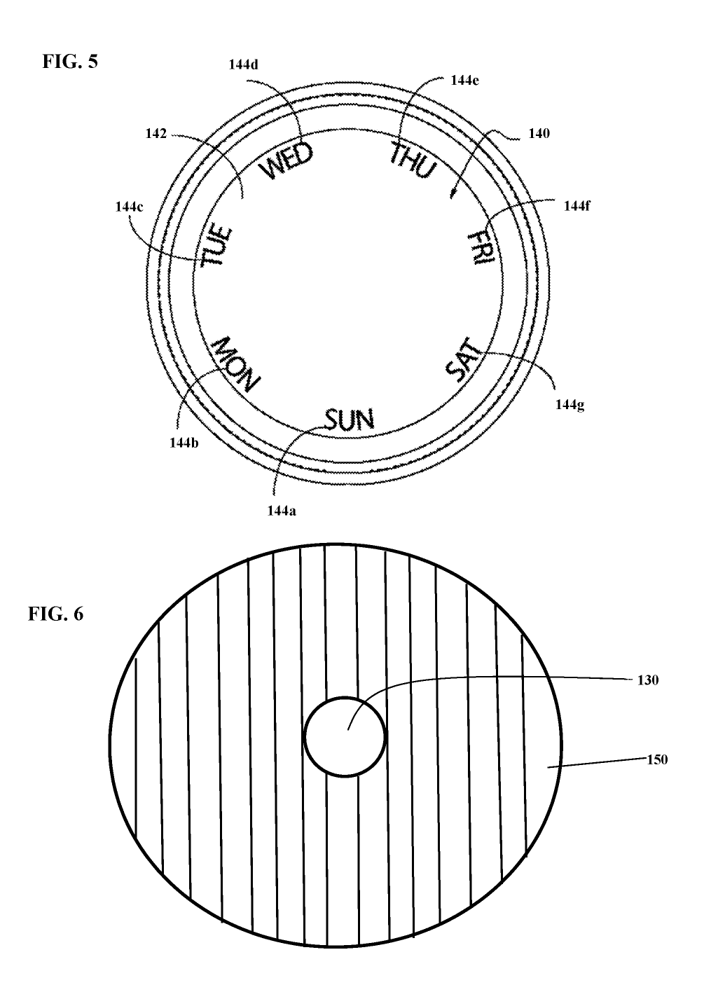

As shown in FIG. 3B, an alternative embodiment of the pill cap 100a without the circular enclosure 120, and the pill cap 100a comprises a central pin 130a disposed through the central axis of the circular disc 140a disposed on the top of a circular portion 170. The circular portion 170 includes a plurality of locking receivers 172 as to receive a locking member 152 operably coupled with a bottom portion of the circular disc 140a. The locking member 152 is operably coupled with a top receiver portion 154 that includes a spring loaded mechanism for the locking member 152 to move vertically in the direction of arrow 156. The locking member 152 sits and locks into a locking portion 174 of the locking receivers 172 as to prevent any further clockwise or counterclockwise movement of the circular disc 140a. The locking portion 174 may be complementary and fit the distal end of the locking member 152. When the user pushes downward on the circular disc 140a, the locking member 152 may be displaced from the locking portion 174 and the locking receiver 172 as to move to the next indicator. Each locking receiver 172 may be associated with a single indicator. The circular portion 170 includes a plurality of indicators to indicate to the user which day or time remains to take a pill or medication. The circular disc 140a may be operably coupled to the central pin 130 by way of springs 162 or other securing methods as to not allow the circular disc 140a to rotate when the bottle rotates. A seal 150a is disposed on the bottom portion of the central pin 130 as to secure the pill cap 100a to on the bottle 200. In one embodiment, the seal 150a includes a circumference or diameter larger than the inner diameter of the bottle 200. A spring 160 is operably coupled with the top portion of the seal 150 as to bias the seal 150. The top portion of the circular portion 170 is shown in FIG. 4B, operably coupled with the central pin 130a. In one embodiment, the locking receivers 172 include a plurality of openings 174 as to receive the locking member 152 and prevent further opening. When the user pushes downward on the circular disc 140a, the locking member 152 disengages from the opening 174 as to allow the circular disc 140a to rotate clockwise or counterclockwise to the next locking receiver 172, which allow the circular enclosure 120 to show one indicator or one section on the circular disc 140, as further described below.

In one embodiment, the bottle 200 may be a standard prescription medicine vial. In other embodiments, the bottle may a medicine container, an over-the-counter vitamin container, an over-the-counter supplement container, or a prescription supplement or vitamin container. In one or more embodiments an already existing container and an already existing closure for containers can be adapted to form the bottle. The medicine containers can contain pills, capsules, tablets, vitamins, supplements, or other forms of medication.

FIG. 4A shows the top portion of the circular enclosure 120 including an opening or window 122. The window 122 shows the indicator 142 disposed on the top portion of the circular disc 140. The indicator 142 is shown to be the day of the week, namely, Monday, which is abbreviated MON. The indicators can indicate day or times of day in any increment of time. The indicators can include: a Sunday indicator, a Monday indicator, a Tuesday indicator, a Wednesday indicator, a Thursday indicator, a Friday indicator, a Saturday indicator, or combinations thereof. Alternatively, the indicators may be time of day that can provide time indications in one hour increments, in two hour increments, or in daily increments. The time of day indicators can be imprinted on the circular disc. In one or more embodiments the time indicators can include: a 6 am indicator, an 8 am indicator, a 10 am indicator, 12 noon indicator, a 2 pm indicator, a 4 pm indicator, a 6 pm indicator, an 8 pm indicator, a bed indicator, a wake indicator, or combinations thereof. The bed indicator can indicate an eight hour sleep period, thereby forming a 24 hour clock. Alternatively, a wake indicator may indicate that an eight hour sleep period has been completed and the user must take the morning dosage of medications.

FIG. 5 shows the circular disc 140 indicating time in daily increments. The top portion 142 of the circular disc 140 can include an indicator 144a shown as “SUN”, indicating Sunday; time indicator 144b, shown as “MON”, indicating Monday; time indicator 144c, shown as “TUE”, indicating Tuesday; time indicator 144d, shown as “WED”, indicating Wednesday; time indicator 144e, shown as “THU”, indicating Thursday; time indicator 144f, shown as “FRI”, indicating Friday; and time indicator 144g, shown as “SAT”, indicating Saturday.

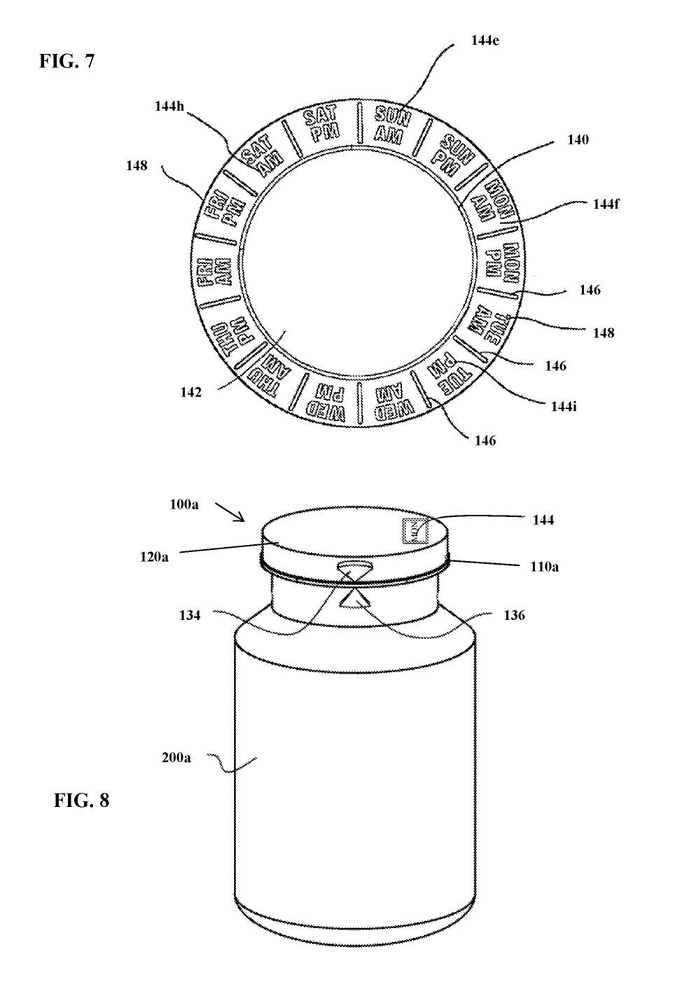

In operation, the window 122 on the circular enclosure 120 will expose the day on which the user is supposed to take his or her medication. When the user disengages the circular enclosure 120 from the bottle 200, the user will have to close the bottle 200 by re-engaging or threading the bottle 200 with the circular enclosure 120. The user will rotate the circular enclosure 120 on the top portion of the bottle 200 and the threaded region, and in doing so; the user will rotate the window 122 to next indicator on the top portion of the circular disc 140, which is when the user is supposed to take the pill or medication. For example, if the user disengages the circular enclosure 120 on a Monday and then takes the pill or medication and re-engages and closes the circular enclosure 120 on the bottle 200, the window 122 will rotate to the next day of Tuesday into the window 122. In alternative embodiments, the rotation of the circular enclosure 120 will rotate the circular disc 140 about its axis to the next adjacent indicator to be exposed through the window 122 on the circular enclosure 120. The spring 160 may bias the circular disc 140 to rotate exactly one indicator. The tabs 132 may prevent the circular disc 140 from rotating multiple indicators, thus preventing extended rotation. Alternatively, ridges may be provided between each indicator and the ridges are disposed on the bottom surface of the top portion of the circular enclosure 120 and the top surface of the circular disc 140 includes conforming indents for the ridges as to prevent the circular disc 140 from rotating more than one indicator. Alternatively, the ridges may be disposed between each indicator on the top portion of the circular disc 140 and the bottom surface of the top portion of the circular enclosure 120 includes conforming indents between each indicator as to receive each ridge on the circular disc 140. As such, each adjacent indicator is separate by a raised ridge portion, as indicated in FIG. 7.

In an alternative embodiment, the circular enclosure 120 or the circular disc 140 may rotate by way of a ratchet mechanism. A ratchet is a mechanical device that allows rotary motion in only one direction while preventing motion in the opposite direction. A ratchet consists of a round gear with teeth, and a pivoting, spring-loaded finger called a pawl that engages the teeth. The teeth are uniform but asymmetrical, with each tooth having a moderate slope on one edge and a much steeper slope on the other edge. When the teeth are moving in the unrestricted (i.e., clockwise) direction, the pawl easily slides up and over the gently sloped edges of the teeth, with a spring forcing it (often with an audible ‘click’) into the depression between the teeth as it passes the tip of each tooth. When the teeth move in the opposite (counterclockwise) direction, however, the pawl will catch against the steeply sloped edge of the first tooth it encounters, thereby locking it against the tooth and preventing any further motion in that direction.

Embodiments of the pill cap 100 enable users to see the original label on the original medicine container while simultaneously monitoring the status of the pills taken. Users of the pill cap 100, such as patients, can travel with the original medicine container or bottle. Traveling with the original medicine container, rather than another pill planner, allows users to travel with all of the information associated with the medication, including the name of the medication, the prescribing doctor, the dosage, the risks and dangers of the medication, refill information, as well as other information associated with the medication.

FIG. 7 shows an alternative embodiment of the circular disc 140, with time and day indicators 144. The top portion 142 or the circular disco 140 includes a plurality of dividing ridges 146 along the circumference of the circular disc to create a plurality of sections 148. In one embodiment, there may be 14 sections 148, although any number of sections may be created depending on the dosage and timing of medication for the user. Each section 148 has indicia for the day of the week, such as indicia 144h and indicia for ante meridem (AM) or post meridem (PM), such as indicia 144i. Thus, 7 of these sections each have a day of the week with a morning indicia and 7 more of these sections repeat the day of the week but include a post-noon indicia. Thus, the cap 100 includes a circular pattern that has a 14 position set of indicia. With this arrangement, the circular enclosure 120 may be rotated to an outer circle sector to simultaneously select both a day of the week and morning or afternoon by being exposed through the window. The dividing ridges 146 may act as stop ridges that keep the circular enclosure 120 in its selected position. A user taking medication may be required to take the medication 1, 2 or 3 times a day and each time the medication is taken and the pill cap 100 is closed onto a bottle or container, the indicator is reset to the next time period required time to take the medication.

FIG. 7 shows another embodiment of the bottle 200a. The pill cap 100a may be engaged over bottle 200a. The indicator 144 is shown through the window of the circular enclosure 120a. An open indicator 134 can be disposed on the side surface of the circular enclosure 120a. The open indicator 134 can be aligned with the indicator 136 for attaching or detaching the circular enclosure 120a from the bottle 200a. Once the user closes the circular enclosure 120a over the bottle 200a and rotates the circular enclosure 120a, the indicator will switch to the next indicator for the user to take medication. The bottom portion 110a includes a ridge that pops onto the top portion of the bottle 200a as to lock the pill cap 100a onto the bottle 200a.

In other embodiments, the pill cap 100 may be operably coupled with a computer system, which may include one or more servers. In some embodiments, computer system includes user computer (e.g., cellular phone, tablet computer, laptop computer, personal digital assistant (PDA), smart watch or desktop computer), pharmacy computer, and/or physician's computer.

The pill cap 100 may be communicatively coupled via communications capability to one or more (e.g., all) of computer system, user computer, pharmacy computer, and/or physician's computer. As shown in FIG. 3A, in some embodiments, the pill cap 100 includes a wireless transmitter 190 or transceiver for transmitting and/or receiving communications, including, for example, a cellular modem (e.g., Telit CC864-Dual, Sierra Wireless 6087 or 5011, or Janus CDMA Terminus Plug-In CDMA864C). Communications capability may be a wireless link (e.g., radio frequency (RF) link, Bluetooth link, 2G link, 3G link), other communications link, or combination of communication links. In various embodiments, the pill cap 100 may utilize the same or different communications links for communicating with different computers (e.g., utilizing different communications links for communicating with computer system and user computer). The communications may indicate to a user's cell phone, smart watch, or physician when the user has taken the medication and when time has passed for the user to take the next prescribed dosage.

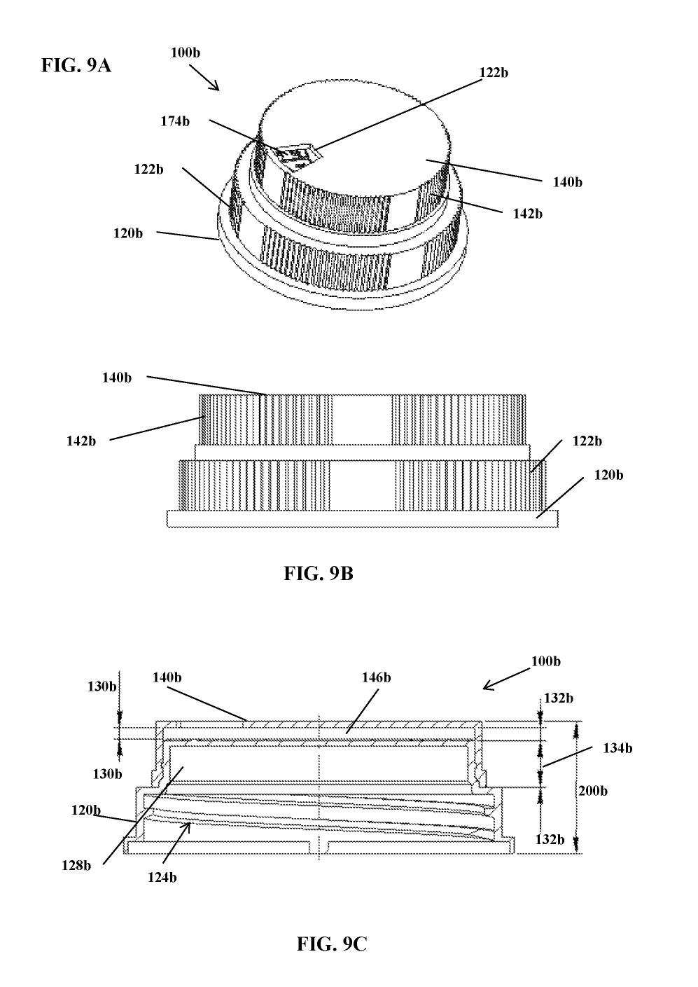

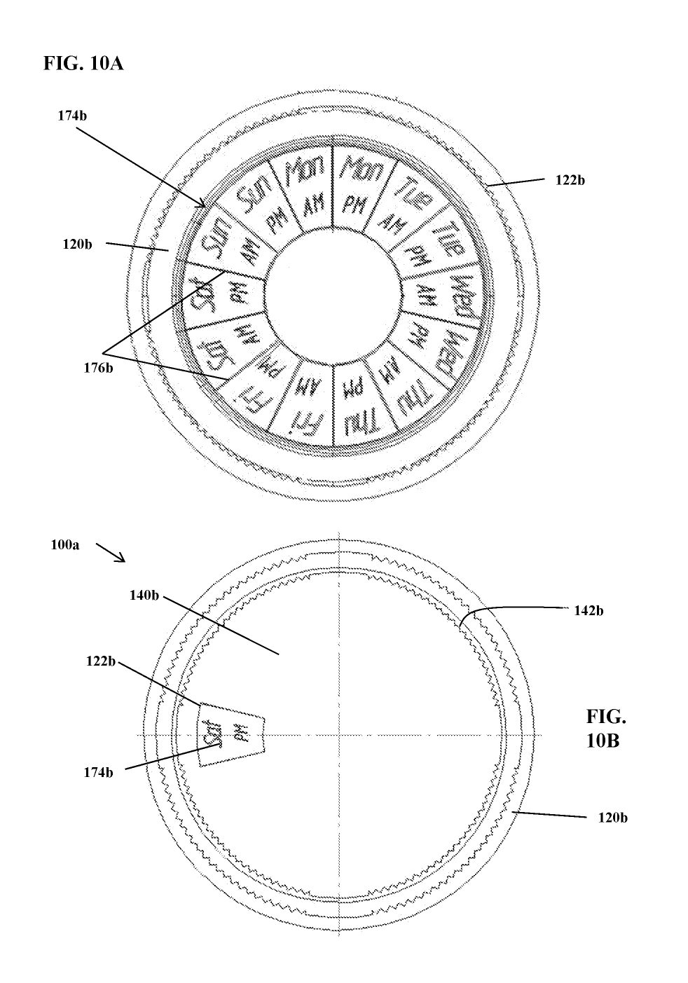

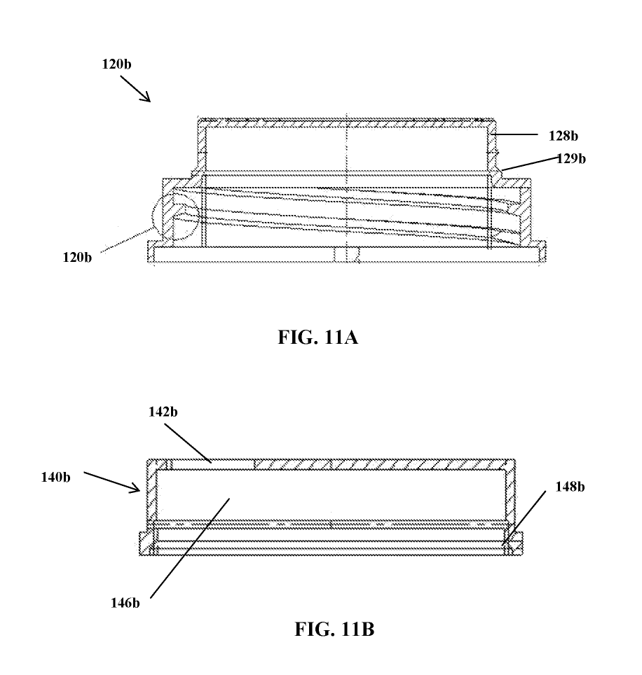

As shown in FIGS. 9A-9B, an alternative embodiment of the pill cap 100b with the circular enclosure 120b, where the pill cap 100b comprises a circular enclosure 120b to be disposed on top of the bottle 200 and rotatable about a central axis of the circular enclosure 120b. The pill cap 100b comprises a circular disc 140b rotatably disposed on the top of the circular enclosure 120b. As shown in FIG. 9C, a space 130b is provided between the circular enclosure 120b and the circular disc 140b, such that the circular disc 140b may rotate on top of the circular enclosure 140b. The circular enclosure 120b includes a raised portion 128b as to fit within the interior space 146b of the circular disc 140b, as shown in FIGS. 11A-11B. The interior space 146b may include an inner ridge 148b and the raised portion 128b may include an outer ridge 129b, such that the circular disc 140b may rotate about the raised portion 128b in a fixed manner. The inner ridge 148b includes a diameter slightly larger than the outer ridge 129b of the raised portion 128b. The circular disc 140b may include a height 132b that is greater than the height 134b of the raised portion 128b. The circular disc 140b includes a circular exterior surface 142b and the circular enclosure 120b includes a circular exterior surface 122b, where the user is able to grip and turn the circular enclosure 120b, as shown in FIGS. 9B and 10B.

As shown in FIGS. 9C and 11a, the circular enclosure 120b includes an interior threaded surface 124b such that the circular enclosure 120b may be secured to top of the bottle 200. In one embodiment, the secure mechanism includes a child proof safety mechanism which requires the user to push downward on the circular enclosure 120b in order to rotate the circular enclosure 120b to the open position of the bottle 200.

When the user pushes downward on the circular enclosure 120b to release the child proof locking mechanism on the bottle 200, the circular disc 140b is rotatably displaced from the currently displayed indicator 174b and the window 122b as to move to the next indicator 174b. As shown in FIG. 10A, the circular enclosure 120b may include a stop feature 176b to prevent the window 122b from rotating more than one indicator upon rotation of the circular enclosure. As shown in FIG. 10A, the circular enclosure 120b includes a plurality of indicators 174b on the top surface of the raised portion 128b to indicate to the user which day or time remains to take a pill or medication. As indicated previously, the circular enclosure 120b includes a circular exterior surface 122b by which the user may grip the circular enclosure 120b. In one embodiment, the circular exterior surface 122b includes a plurality of peaks and troughs. In other embodiment, the circular exterior surface 122b may include a roughened surface that has an increased roughness with respect to the other surfaces of the circular enclosure 120b.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. An pill cap apparatus comprising:
a circular enclosure including a top portion and a bottom portion, wherein the bottom portion engages a top portion of a bottle, and top portion includes a window;
a central pin disposed through the central axis of the circular enclosure;
a circular disc disposed in the top portion of the circular enclosure, wherein the circular disc includes a plurality of indicators disposed along the circumference of the circular disc to indicate to the user which day or time remains to take a pill or medication, and the circular disc fixedly attached to the central pin;
a seal disposed on a bottom portion of the central pin as to seal the circular enclosure from the bottle;
a spring operably coupled with the top portion of the seal and the top portion of the circular enclosure;
wherein the circular enclosure rotates a single indicator when the circular enclosure is rotated to close on the top portion of the bottle.

2. The pill cap apparatus of claim 1, wherein the bottom portion of the circular enclosure includes a plurality of threaded receptions as to be received by a threaded region of the bottle and to secure the circular enclosure to the bottle by way of rotation.

3. The pill cap apparatus of claim 2, wherein the circular disc is fixedly attached to the central pin by way of tabs.

4. The pill cap apparatus of claim 3, wherein a top portion of the bottle includes a threaded region including a single thread helically wrapped around the threaded region.

5. The pill cap apparatus of claim 4, wherein the top portion of the bottle includes a lever that locks the circular enclosure with the top portion of the bottle, and the lever is bias towards the upward position.

6. The pill cap apparatus of claim 5, wherein the circular enclosure is threaded with the top portion of the bottle with the circular enclosure as to rotate the window to the adjacent indicator on the top portion of the circular disc.

7. The pill cap apparatus of claim 5, wherein the rotation of the circular enclosure rotates the circular disc about its axis to the next adjacent indicator to be exposed through the window on the circular enclosure.

8. The pill cap apparatus of claim 7, wherein the spring biases the circular disc to rotate one indicator when the circular enclosure is rotated.

9. The pill cap apparatus of claim 6, wherein the window on the circular enclosure rotates by way of a ratchet mechanism.

10. A pill cap apparatus comprising:
a central pin disposed through a central axis of a circular disc;
a circular portion disposed on the bottom of the circular disc with the central pin disposed through the central axis of the circular portion, the circular portion includes a plurality of locking receivers as to receive a locking member operably coupled with a bottom portion of the circular disc;
the locking member operably coupled with a top receiver portion that includes a spring loaded mechanism for the locking member to move vertically with respect to the circular portion, wherein the locking member sits and locks into a locking portion of the locking receivers as to prevent any further clockwise or counterclockwise movement of the circular disc;
each locking receiver is associated with a single indicator, wherein the circular portion includes a plurality of indicators to indicate to the user which day or time remains to take a pill or medication
a seal operably disposed on the bottom portion of the central pin as to secure the pill cap to a bottle.

11. The pill cap apparatus of claim 10, wherein the locking portion complementarily fits a distal end of the locking member; and the locking member is displaced from the locking portion and the locking receiver when downward pressure is applied to the circular disc.

12. The pill cap apparatus of claim 11, wherein the circular disc is operably coupled to the central pin by way of springs as to not allow the circular disc to rotate when the bottle.

13. The pill cap apparatus of claim 12, wherein the seal includes a diameter larger than the inner diameter of the bottle, and a spring is operably coupled with the top portion of the seal as to bias the seal.

14. A pill cap apparatus comprising:
a circular enclosure rotatable about a central axis and a circular disc rotatably disposed on the top of the circular enclosure, wherein a space is provided between the circular enclosure and the circular disc, such that the circular disc may rotate on top of the circular enclosure;
the circular enclosure includes a raised portion, and the circular disc including an interior space, such that the raised portion is rotatable within the interior space;
the circular enclosure includes a plurality of indicators on the top surface of the raised portion to indicate to the user which day or time remains to take a pill or medication;
the interior space includes an inner ridge and the raised portion includes an outer ridge, such that the circular disc rotate about the raised portion in a fixed manner;
the inner ridge includes a diameter larger than the diameter of the outer ridge of the raised portion;
the circular disc includes a height that is greater than a height of the raised portion;
the circular enclosure includes an interior threaded surface such that the circular enclosure is rotatably secured to top of a bottle; and
when the user pushes downward on the circular enclosure to rotate the child proof locking mechanism on the bottle, the circular disc is rotatably displaced from the a displayed indicator through a window on the circular disc as to move to a next indicator.

15. The pill cap apparatus of claim 14, wherein the circular disc includes a circular exterior surface and the circular enclosure includes a circular exterior surface; wherein the circular exterior surface includes a plurality of peaks and troughs.

16. The pill cap apparatus of claim 15, wherein the interior threaded surface includes a secure mechanism that requires the user to push downward on the circular enclosure in order to rotate the circular enclosure to the open position of the bottle.

17. The pill cap apparatus of claim 16, wherein the circular enclosure includes a stop feature around each indicator to prevent the window from rotating more than one indicator upon rotation of the circular enclosure.
